(19) United States
(12) Patent Application Publication
(10) Pub. No.: US 2006/0217844 A1
(43) Pub. Date: Sep. 28, 2006

(54) Self-propelled cleaner

(75) Inventor: Ryo Saeki, Osaka (JP)

Correspondence Address: Yokoi & Co.;U.S.A., Inc., #723, 13700 Marina Pointe Drive, Marina Del Rey, CA, 90292, US

(73) Assignee: Funai Electric Co., Ltd., Osaka (JP)

(21) Appl. No.: 11/386,440

(22) Filed: Mar. 22, 2006

(30) Foreign Application Priority Data
Mar. 24, 2005 (JP) JP2005-086322

(51) Int. Cl. G06F 19/00

(52) U.S. Cl. 700/258; 700/245

(57) ABSTRACT

A self-propelled cleaner that can travel accurately along a wall edge and preferably remove dust in the wall edge is provided. Since the self-propelled cleaner is configured in a way that direction correction in two steps is performed, that is, a direction of a body BD is corrected to be perpendicular to the from obstacle (wall W) using ultrasonic sensors 31 (31a to 31c), and the body BD is turned by 90 degrees in that condition, and then the direction of the body BD is corrected to be parallel to the obstacle (wall W) using lateral wall sensors 36 (36FR, 36FL, 36RR and 36RL), the body can be accurately parallel to the wall, can be accurately travel along the wall edge.

### BACKGROUND OF THE INVENTION

1. Field of the Invention

The present invention relates to a self-propelled cleaner having a driving mechanism and a cleaner mechanism.

2. Description of the Related Art

Self-propelled cleaners having a driving mechanism for realizing steering and driving and a cleaner mechanism for cleaning operation have been known (for example, refer to JP-A-05-046246).

Among such self-propelled cleaners, a self-propelled cleaner has been proposed which can perform self-propelled cleaning, that is, perform cleaning operation while automatically traveling and changing a course every time it senses an obstacle in a room.

In the case that a self-propelled cleaners that performs the self-propelled cleaning as described above is used, there has been a problem that unless a body travels accurately along a wall edge in the room, particularly, dust in the wall edge can not be preferably removed.

### SUMMARY

The present invention aims at providing a self-propelled cleaner that can travel accurately along the wall edge and preferably remove the dust in the wall edge.

According to one embodiment of the invention, a self-propelled cleaner includes a driving mechanism for realizing steering and driving, a cleaner mechanism, a gyro sensor for detecting an angle of direction to which the body is coursing, front obstacle sensors that sense a front obstacle and measure a distance to the obstacle, and lateral wall sensors that sense a lateral obstacle and generate sensor output values in accordance with the distance to the obstacle, wherein,

the front obstacle sensors are disposed at least at three places of a central portion of a front face of the body, and right and left, two sides at the back of the central portion,

front lateral-wall sensors disposed at right and left, two sides of the front side of the body, and rear lateral-wall sensors disposed at right and left, two sides of the back side of the body are included as the lateral wall sensors, and

the cleaner includes a vertical correction and control mechanism that corrects a direction of the body to be perpendicular to the front obstacle using the front obstacle sensors disposed at the three places, and

a parallel correction and control mechanism that turns the body by 90 degrees using the gyro sensor after the direction of the body has been made perpendicular to the front obstacle by the vertical correction and control mechanism, and then corrects the direction of the body to be parallel to the obstacle.

In the invention configured as above, the self-propelled cleaner includes a driving mechanism for realizing steering and driving, a cleaner mechanism, a gyro sensor for detecting an angle of direction to which the body is coursing, front obstacle sensors for sensing the front obstacle, and lateral wall sensors for sensing the lateral obstacle, wherein the front obstacle sensors are disposed at least at three places of about the central portion of the front face of the body, and right and left two sides at the back of the central portion, and the lateral wall sensors include front lateral-wall sensors disposed at the right and left, two sides of the front side of the body, and the rear lateral-wall sensors disposed at the right and left, two sides of the back side of the body.

The self-propelled cleaner includes the vertical correction and control mechanism that corrects the direction of the body to be perpendicular to the front obstacle using the front obstacle sensors disposed at the three places, and the parallel correction and control mechanism that turns the body by 90 degrees using the gyro sensor after the direction of the body has been made perpendicular to the front obstacle by the vertical correction and control mechanism, and then corrects the direction of the body to be parallel to the obstacle using the front lateral-wall sensors and the rear lateral-wall sensors. The direction of the body is made perpendicular to the front obstacle by the vertical correction and control mechanism, and then the body is turned by 90 degrees using the gyro sensor, thereby the direction of the body is approximately parallel to the obstacle, and then in addition to this, the parallel correction and control mechanism is used, thereby the direction of the body is made accurately parallel to the obstacle. In this way, the two steps of position correction units are used, thereby the body can be made accurately parallel to a wall, and consequently the cleaner is allowed to accurately travel along the wall edge. As a result, the dust in the wall edge can be preferably removed. Moreover, even if one of the front obstacle sensors and the lateral wall sensors is disabled, the direction of the body can be corrected by using one of effective sensors.

Another embodiment of the invention is configured in a way that the vertical correction and control mechanism turns the body by a certain angle in the clockwise direction when the obstacle is sensed by the front obstacle sensor at the right while the body is traveling to the obstacle, and the mechanism turns the body by a certain angle in a counterclockwise direction when the obstacle is sensed by the front obstacle sensor at the left.

In a configuration as above, when the front obstacle is sensed by the front obstacle sensor disposed at the right of the body, that is, when the body is inclined to the left with respect to the obstacle, the body can be corrected to be perpendicular to the obstacle by rotating the body in the clockwise direction, and when the front obstacle is sensed by the front obstacle sensor disposed at the left of the body, that is, when the body is inclined to the right with respect to the obstacle, the body can be corrected to be perpendicular to the obstacle by rotating the body in the counterclockwise direction.

Still another embodiment of the invention is configured in a way that when a sensor output value of the front lateral-wall sensor at the left is larger than that of the rear lateral-wall sensor at the left, or when a sensor output value of the rear lateral-wall sensor at the right is larger than that of the front lateral-wall sensor at the right, the parallel correction and control mechanism turns the body by a certain angle in the clockwise direction, and when a sensor output value of the front lateral-wall sensor at the right is larger than that of the rear lateral-wall sensor at the right, or when a sensor output value of the rear lateral-wall sensor at the left is larger than that of the front lateral-wall sensor at the left, the mechanism turns the body by a certain angle in the counterclockwise direction.

When the cleaner is configured as described above, one of the front lateral-wall sensors and the rear lateral-wall sensors lies near to the obstacle, and when one of sensor output values is larger due to this, the direction of the body can be corrected to be parallel to the obstacle by turning the body.

### BRIEF DESCRIPTION OF THE DRAWINGS

FIG. 1 is a perspective outline view of a self-propelled cleaner according to the invention;

FIG. 2 is a bottom view of the self-propelled cleaner shown in FIG. 1;

FIG. 3 is a block diagram showing a configuration of the self-propelled cleaner shown in FIGS. 1 and 2;

FIG. 4 is a view showing an example of a traveling route along which the self-propelled cleaner travels;

FIG. 5 is a flowchart showing a flow of position correction processing performed by the self-propelled cleaner;

FIG. 6 is an illustrative view for illustrating the position correction processing shown in FIG. 5; and

FIG. 7 is an illustrative view for illustrating the position correction processing shown in FIG. 5.

### DETAILED DESCRIPTION

Hereinafter, preferred embodiments of the invention will be described in the following order:

(1) Outline of self-propelled cleaner;

(2) Internal configuration of self-propelled cleaner;

(3) Operation of self-propelled cleaner; and

(4) Summary.

(1) Outline of Self-Propelled Cleaner

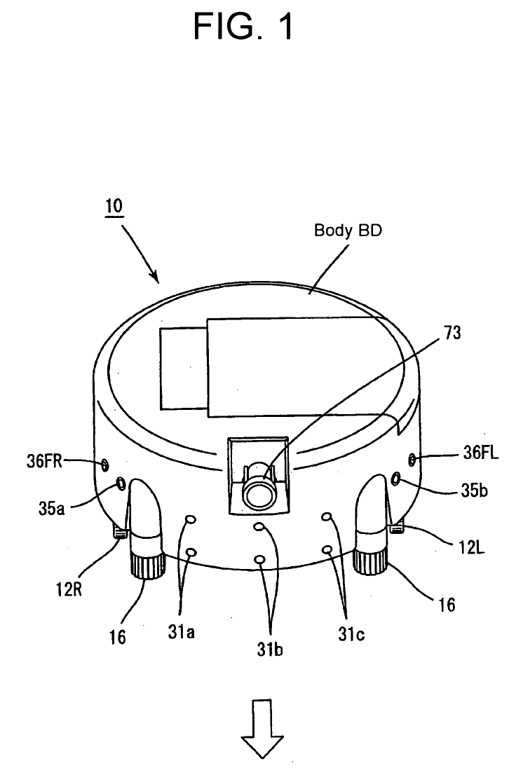

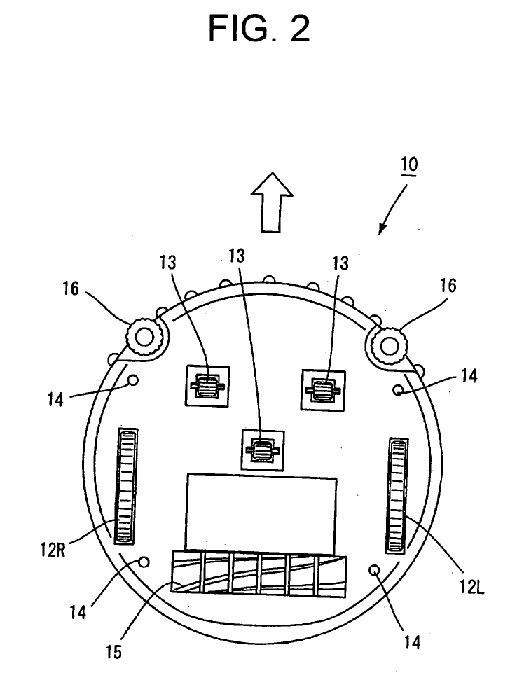

FIG. 1 is a perspective outline view showing the self-propelled cleaner according to the invention. FIG. 2 is a bottom view of the self-propelled cleaner shown in FIG. 1. In FIG. 1, a direction indicated by an arrow A is an advance direction in forward movement of the self-propelled cleaner. As shown in FIG. 1, the self-propelled cleaner 10 according to the invention includes an approximately cylindrical body BD, and can be advanced, retreated and turned with a certain rotation axis as a center by separately driving two drive wheels 12R, 12L (see FIG. 2), the wheels being provided on a bottom of the body BD. Furthermore, an infrared CCD sensor 73 as an image pickup sensor is provided at a central portion of the front side of the body BD.

Moreover, three ultrasonic sensors 31 (31a to 31c) that act as the front obstacle sensors are provided below the infrared CCD sensor 73. The ultrasonic sensors 31 include transmitter sections for generating supersonic waves and receiver sections for receiving the supersonic waves that are transmitted by the transmitter sections, reflected by a front wall, and returned, and can calculate a distance to the wall from a period between transmission of the supersonic waves by the transmitter sections and reception of the waves by the receiver sections. Among the three ultrasonic sensors 31, the ultrasonic sensor 31b is provided at the central portion of the front face of the body BD, the ultrasonic sensor 31a is provided at the right with respect to the advance direction, and the ultrasonic sensor 31c is provided at the left with respect to the direction, respectively. The ultrasonic sensor 31a at the right and the ultrasonic sensor 31c at the left are disposed at the back of the ultrasonic sensor 31b at the central portion.

Moreover, pyroelectric sensors 35 (35a, 35b) as human body sensors are provided at the left and right, two sides of the front side of the body BD. The pyroelectric sensors 35a, 35b detect infrared rays generated from the human body, thereby they can sense the human near the body BD. While not shown in FIG. 1, pyroelectric sensors 35 (35c, 35d) are also provided at left and right, two sides of a back side of the body BD respectively. Thus, the pyroelectric sensors 35 are configured such that they have a sensing range of 360 degrees around the body BD.

Moreover, on the left and right, two sides of the front side of the body BD, front lateral-wall sensors 36F (36FR, 36FL) including photo-reflectors as described later are provided respectively. The photo-reflectors are for detecting a lateral wall to keep a certain interval to the wall during traveling, and used for detecting a charger when automatic charge described later is performed. While not shown in FIG. 1, rear lateral-wall sensors 36R (36RR, 36RL) including the photo-reflectors are also provided on the left and right, two sides of the rear side of the body BD respectively. Any of the lateral wall sensors 3 generates a larger sensor output value with decrease in distance to the lateral wall.

In FIG. 2, the two drive wheels 12R, 12L are provided at the left and right, two ends of the center of the bottom of the body BD. Moreover, three auxiliary wheels 13 are provided at a front side (advance direction side) of the bottom of the body BD respectively. Furthermore, step sensors 14 for sensing unevenness or a step of a floor surface are provided at the upper right, lower right, upper left and the lower left of the bottom of the body BD. A main brush 15 is provided at a region lower than the center of the bottom of the body BD. The main brush 15 is rotationally driven by a main brush motor 52 (not shown) and can sweep dust on the floor surface. Moreover, an opening in a portion to which the main brush 15 is attached acts as a suction port, and the dust is sucked into the suction port while being swept by the main brush 15. Furthermore, side brushes 16 are provided at the upper right and the upper left of the bottom of the body BD, respectively.

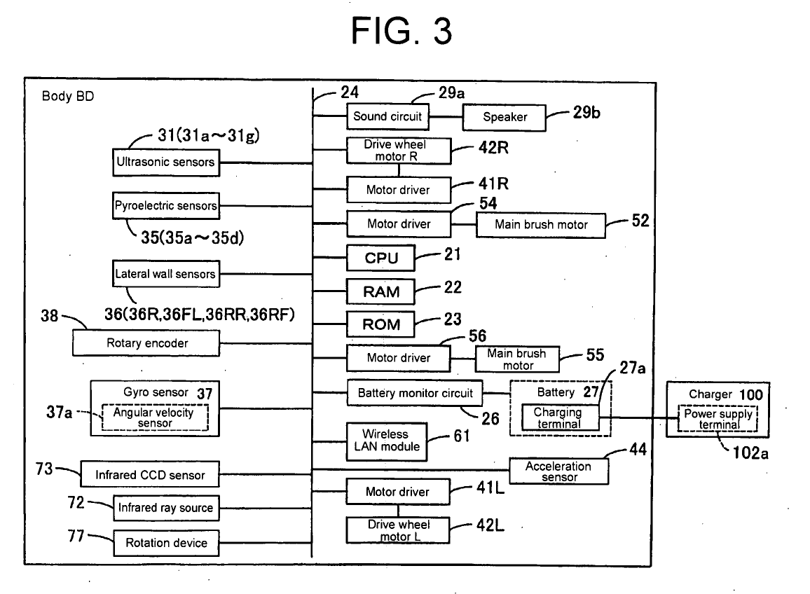

While the self-propelled cleaner 10 according to the invention has various sensors in addition to the ultrasonic sensors 31, pyroelectric sensors 35 and step sensors 14 as shown in FIGS. 1 and 2, which are described later using a drawing (FIG. 3).

(2) Internal Configuration of Self-Propelled Cleaner

FIG. 3 is a block diagram showing a configuration of the self-propelled cleaner shown in FIGS. 1 and 2. In the figure, CPU 21 as a control section, ROM 23, and RAM 22 are connected to the body BD via a bus 24. The CPU 21 uses the RAM 22 as a work area to execute various types of control according to a control program and various parameter tables stored in the ROM 23.

The body BD has a battery 27, and the CPU 21 may monitor residual quantity of the battery 27 via a battery monitor circuit 26. Moreover, the battery 27 has a charging terminal 27a for charging the battery by a charger 100. A power supply terminal 102a of the charger 100 is connected to the charging terminal 27a for charging. The battery monitor circuit 26 mainly performs monitoring of voltage of the battery 27 and thus senses the residual quantity of the battery 27. Furthermore, the body BD has a sound circuit 29a connected to the bus 24, and a speaker 29b generates sound according to a sound signal generated in the sound circuit 29a.

The body BD has the ultrasonic sensors 31 (31a to 31c) as the front obstacle sensors, pyroelectric sensors 35 (35a to 35d) as human body sensors, and step sensors 14 (see FIGS. 1 and 2). Moreover, the body BD has lateral wall sensors 36 (36FR, 36FL 36RR, 36RL) for detecting the lateral wall. The lateral-wall sensors 36 include the photo-reflectors having light emitting sections that emit infrared rays and light receiving sections that receive the infrared rays reflected by the wall, however, as other lateral-wall sensors that can be used in the invention, ultrasonic sensors and the like can be used. Furthermore, the body BD has a gyro sensor 37 as one of the other sensors. The gyro sensor 37 has an angular velocity sensor 37a for detecting change in angular velocity due to change in advance direction of the body BD, and can detect an angle of direction to which the body BD is coursing by integrating sensor output values detected by the angular velocity sensor 37a.

The self-propelled cleaner 10 according to the invention has motor drivers 41R, 41L, drive wheel motors 42R, 42L, and a not-shown gear unit arranged between the drive wheel motors 42R, 42L and the drive wheels 12R, 12L as a drive mechanism. In the drive wheel motors 42R, 42L, a rotation direction and a rotation angle are controllably driven in full by the motor drivers 41R, 41L when they travel with turns. According to control instructions from the CPU 21, the respective motor drivers 41R, 41L output driving signals corresponding to the instructions. There are various types of the gear unit and the drive wheels 12R, 12L, which may be used, and they may be realized by circular rubber tires to be driven or an endless belt to be driven.

Moreover, the body BD has rotary encoders 38. The rotary encoders 38 are mounted integrally with the drive wheel motors 42R, 42L, thereby travel distance of the body BD can be calculated from the rotational frequency of the drive wheels 12R, 12L. The rotary encoders may not be directly coupled to the drive wheel motors, and may be configured in a way that freely rotatable, driven wheels are mounted near the drive wheels, and rotational amounts of the driven wheels are fed back, thereby actual rotational amounts can be sensed even if the drive wheels slip. Furthermore, an acceleration sensor 44 senses acceleration in triaxial directions of X, Y and Z, and outputs detection results.

A cleaner mechanism of the self-propelled cleaner 10 according to the invention includes the two side brushes 16 provided on the bottom of the body BD (see FIG. 2), the main brush 15 provided in the central portion of the bottom of the body BD (see FIG. 2), and a suction fan (not shown) for sucking dust swept by the main brush 15 and storing the dust in a dust box. The main brush 15 is driven by a main brush motor 52, and the suction fan is driven by a suction motor 55. Motor drivers 54, 56 supply driving power to the main brush motor 52 and the suction motor 55, respectively. Cleaning using the main brush 15 is appropriately controlled by the CPU 21 based on determination on the cleaning according to a condition of the floor surface, a condition of the battery, user instructions and the like.

The body BD has a wireless LAN module 61, and the CPU 21 can communicate with external LAN by wireless according to a certain protocol. On condition that there are not-shown access points, the wireless LAN module 61 is assumed to be in an environment connectable to an external broadband network (for example, Internet) via routers or the like. Therefore, a typical mail can be transmitted and received or website can be browsed through Internet. The wireless LAN module 61 includes a standardized card slot, a standardized wireless-LAN card which was coupled with the slot, and the like. It will be appreciated that the card slot can be coupled with other types of standardized cards.

Moreover, the body BD has an infrared CCD sensor 73, and an infrared ray source 72. An image pickup signal generated in the infrared CCD sensor 73 is transmitted to the CPU 21 via the bus 24, and the image pickup signal is subjected to various types of processing in the CPU 21. The infrared CCD sensor 73 has an optical system that can take an image of the front, and generates an electric signal according to infrared rays inputted from a view field realized by the optical system. Specifically, a large number of photodiodes arranged correspondingly to respective pixels at imaging points given by the optical system are provided, and respective photodiodes generate electric signals in correspondence with electric power of the inputted infrared rays. CCD elements temporarily store the electric signals generated for each of pixels, and generate image pickup signals in which electric signals are continued for each of the pixels. Then, the generated image pickup signals are appropriately outputted to the CPU 21.

(3) Operation of Self-Propelled Cleaner

Next, operation of the self-propelled cleaner 10 according to the invention is described.

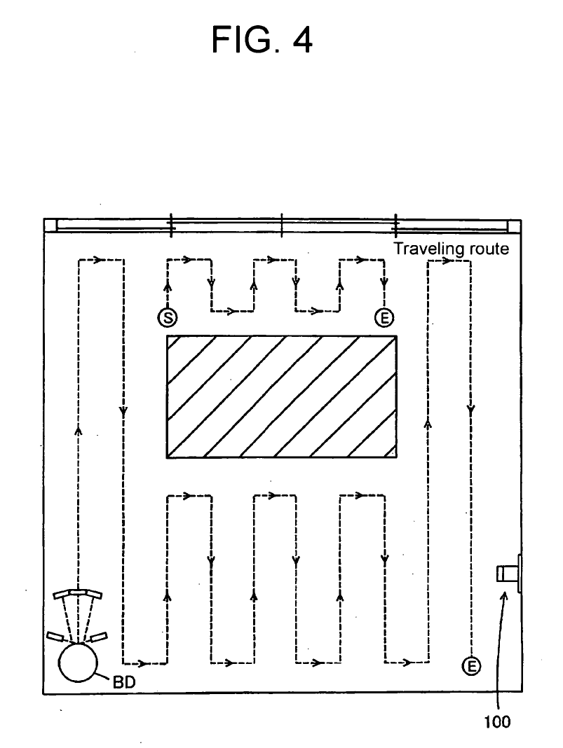

The self-propelled cleaner 10 according to the invention is configured to be capable of cleaning while automatically traveling according to a control program previously stored in the ROM 23 and the like. When irregularity on a wall or a floor surface is sensed by the sensor during cleaning by the cleaner under automatic traveling, the traveling is controlled according to the control program. In the embodiment, as shown in FIG. 4, a case that the self-propelled cleaner 10 travels zigzag in a room by repeating straight traveling and right-angle turns is described. In this case, when an obstacle such as a wall is sensed in the front during straight traveling, position correction processing described later is performed, that is, a direction of the body is corrected to be perpendicular to a front wall, and then the body is turned by 90 degrees, and then the direction of the body is corrected again to be accurately parallel to the wall.

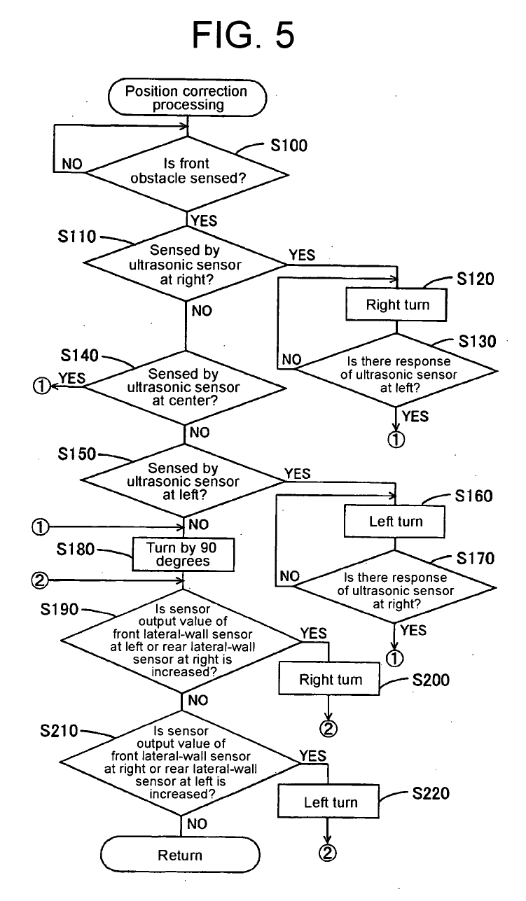

Hereinafter, the position correction processing performed by the self-propelled cleaner 10 according to the embodiment is described according to a flowchart as shown in FIG. 5. FIG. 5 is a flowchart showing a flow of the position correction processing. First, it is determined in step 100 that whether a front obstacle was sensed. In this process, it is determined that whether the front obstacle (such as wall) was sensed by one of the three ultrasonic wave sensors 31 (31a to 31c) while the body straightly travels. In the case that the front obstacle was not sensed, that is, in the case that the obstacle is not sensed by any of the three ultrasonic sensors 31, the processing is returned to the step S100.

On the other hand, when it is determined in step S100 that the front obstacle was sensed, then, it is determined in step S110 that whether the obstacle was sensed by the ultrasonic sensor at the right. That is, it is determined that whether the obstacle was sensed by the ultrasonic sensor 31a disposed at the right with respect to the advance direction among the three ultrasonic sensors 31a to 31c. When it was determined that the obstacle was sensed by the ultrasonic sensor at the right, since the advance direction of the body BD is inclined to the left with respect to perpendicular to the obstacle, a process that the body BD is turned by a certain angle (for example, one degree) in the clockwise direction is performed in next step S120, so that the direction of the body BD is close to perpendicular with respect to the obstacle.

The process in the step S120 has been carried out, then it is determined in step S130 that whether there was response of the ultrasonic sensor at the left. In this process, it is determined that whether the front obstacle was sensed by the ultrasonic sensor 31c at the left. A fact that the obstacle is also sensed by the ultrasonic sensor 31c in the process of the step S130 while the obstacle has been detected by the ultrasonic sensor 31a at the right means that a distance from the ultrasonic sensor 31a at the right to the obstacle is equal to a distance from the ultrasonic sensor 31c at the left to it, or the direction of the body BD is perpendicular to the obstacle. In the step S130, when it is determined that the there is no response of ultrasonic sensor at the left, the processing is returned to the step S120, and on the other hand, when it is determined that the there is response of ultrasonic sensor at the left, the processing is advanced to step S180 described later.

When it is not determined in the step S110 that the front obstacle was sensed by the ultrasonic sensor at the right, then, it is determined in step S140 that whether the front obstacle was sensed by the ultrasonic sensor at the center. When the front obstacle was sensed first by the ultrasonic sensor at the center among the three ultrasonic sensors 31a to 31c, the direction of the body BD is perpendicular to the obstacle. When it is determined in the step S140 that the front obstacle was sensed by the ultrasonic sensor at the center, the processing is advanced to the step S180 described later.

On the other hand, when it is determined in the step S140 that the front obstacle is not sensed by the ultrasonic sensor at the center, then, it is determined in step S150 that whether the obstacle was sensed by the ultrasonic sensor at the left. In this process, it is determined that whether the front obstacle was sensed by the ultrasonic sensor 31c at the left with respect to the advance direction among the three ultrasonic sensors 31a to 31c. When the obstacle was sensed by the ultrasonic sensor at the left, since the advance direction of the body BD is inclined to the right with respect to perpendicular to the obstacle, a process that the body BD is turned by a certain angle in the counterclockwise direction is performed in next step S160, so that the direction of the body BD is close to perpendicular with respect to the obstacle.

The process in the step S160 has been carried out, then it is determined in step S170 that whether there was response of the ultrasonic sensor at the right. In this process, it is determined that whether the front obstacle was sensed by the ultrasonic sensor 31a at the right. When it was determined that there was no response of the ultrasonic sensor at the right, the processing is returned to the step S160, and on the other hand, when it was determined that there was response, the processing is advanced to the step S180.

In the above steps S100 to S170, software processing, and rotational drive of the body BD and the like by the hardware based on the software processing correspond to the vertical correction and control mechanism.

In the step S180, the body BD is turned by 90 degrees. In this process, the body BD is turned while the angle of direction to which the body BD is coursing is detected by the gyro sensor 37, and the body BD is stopped from being turned when it has been turned by 90 degrees.

When the process of the step S180 has been completed, then in step S190, it is determined that whether a sensor output value of the front lateral-wall sensor at the left or the rear lateral-wall sensor at the right is increased. In this process, it is determined that whether a sensor output value of the front lateral-wall sensor 36FL that is the front lateral-wall sensor at the left is larger than that of the rear lateral-wall sensor at the left 36RL, or a sensor output value of the rear lateral-wall sensor 36RR that is the rear lateral-wall sensor at the right is larger than that of the front lateral-wall sensor at the right 36FR. Such difference between the sensor output values is caused by a fact that the direction of the body BD is inclined to the left.

When it was determined in the step S190 that the sensor output value of the front lateral-wall sensor at the left or the rear lateral-wall sensor at the right was increased, since the direction of the body BD is inclined to the left as described above, the body BD is turned by a certain angle in the clockwise direction in next step S200, and then the processing is returned to the step S190.

On the other hand, when it was determined that the sensor output value of the front lateral-wall sensor at the left or the rear lateral-wall sensor at the right was not increased, then in step S210, it is determined that whether a sensor output value of the front lateral-wall sensor at the right or the rear lateral-wall sensor at the left is increased. In this process, it is determined that whether a sensor output value of the front lateral-wall sensor 36FR that is the front lateral-wall sensor at the right is larger than that of the rear lateral-wall sensor at the right 36RR, or a sensor output value of the rear lateral-wall sensor 36RL that is the rear lateral-wall sensor at the left is larger than that of the front lateral-wall sensor at the left 36FL. Such difference between the sensor output values is caused by a fact that the direction of the body BD is inclined to the right.

When it was determined in the step S210 that the sensor output value of the front lateral-wall sensor at the right or the rear lateral-wall sensor at the left was increased, since the direction of the body BD is inclined to the right as described above, the body BD is turned by a certain angle in the counterclockwise direction in next step S220, and then the processing is returned to the step S190. On the other hand, when it was determined that the sensor output value of the front lateral-wall sensor at the right or the rear lateral-wall sensor at the left was not increased, since the body BD is not inclined to both the right and the left, or parallel to the obstacle, the body BD is not turned, and the position correction processing is finished without any additional process.

In the above steps S190 to S220, software processing, and rotational drive of the body BD and the like by the hardware based on the software processing correspond to the parallel correction and control mechanism.

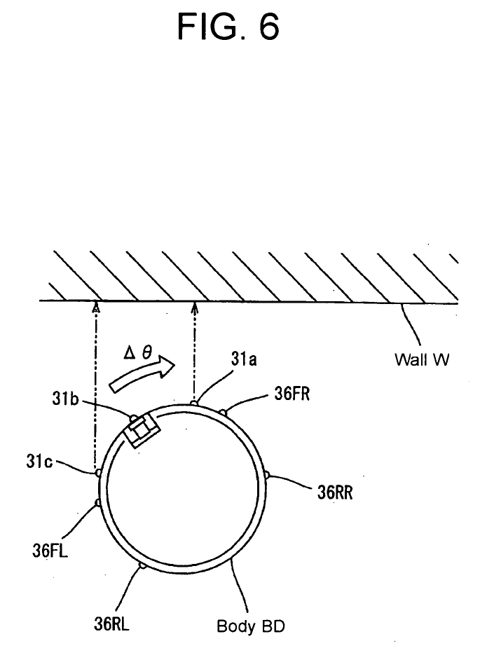

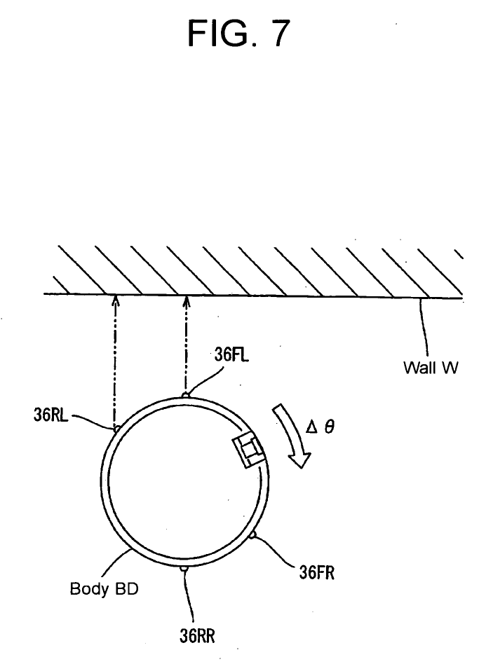

Hereinafter, a specific example in the case that the position correction processing as shown in FIG. 5 is practiced is described using FIG. 6 and FIG. 7. First, while the cleaner travels toward a wall W as the obstacle, when the wall W is sensed by the ultrasonic sensors 31 (step S100: YES), it is determined that which ultrasonic sensor among the three ultrasonic sensors 31a to 31c the wall was sensed by (steps S110, S140 and S150) In FIG. 6, the direction of the body BD is inclined to the left with respect to perpendicular to the wall W, consequently the ultrasonic sensor at the right first senses the wall (step S110: YES).

After that, in order to correct the direction of the body BD, the body BD is turned by a small angle (AO) in the clockwise direction as shown by an outline arrow in FIG. 6. As a result, if there is response to the wall W also in the ultrasonic sensor at the left 31c, the direction of the body BD is regarded to be perpendicular to the wall W, therefore the body BD is turned by 90 degrees (step S180).

While the process of the step S180 is practiced by using the gyro sensor 37, the body may not be accurately turned by 90 degrees due to measurement errors in the gyro sensor 37 and the like, and for example, the body may not be parallel to the wall W as shown in FIG. 7. In an example shown in FIG. 7, the front lateral-wall sensor 36FL lies near to the wall W compared with the rear lateral-wall sensor 36RL, consequently the sensor output value also becomes larger in the front lateral-wall sensor 36FL. In this case, the body BD is turned by a small angle (Δθ) in the clockwise direction (step S200), so that the direction of the body BD is parallel to the wall W.

While a case that the front obstacle sensor is represented as the ultrasonic sensor is described in the embodiment, the front obstacle sensor used for the invention is not limited to the ultrasonic sensor as long as it can sense the front obstacle, and may be an infrared sensor (photo-reflector) having a light emitting section and a light receiving section and the like. Moreover, while a case that the lateral wall sensor is the photo-reflector is described in the embodiment, similarly, the lateral wall sensor is not particularly limited to it as long as the sensor can sense the obstacle such as lateral wall, and may be the ultrasonic sensor and the like.

(4) Summary

As described above, since the self-propelled cleaner 10 according to the invention is configured in a way that the direction correction in two steps is performed, that is, the direction of the body BD is corrected to be perpendicular to the front obstacle (wall W) using the ultrasonic sensors 31 (31a to 31c), and the body BD is turned by 90 degrees in that condition, and then the direction of the body BD is corrected to be parallel to the obstacle (wall W) using the lateral wall sensors 36 (36FR, 36FL, 36RR and 36RL), the body can be accurately parallel to the wall, and can accurately travel along the wall edge.

While the invention has been particularly shown and described with respect to preferred embodiments thereof, it should be understood by those skilled in the art that the foregoing and other changes in form and detail may be made therein without cope of the invention as defined

What is claimed is:

1. A self-propelled cleaner including a driving mechanism for realizing steering and driving, a cleaner mechanism, a gyro sensor for detecting an angle of direction to which the body is coursing, front obstacle sensors that sense a front obstacle and measure a distance to the obstacle, and lateral wall sensors that sense a lateral obstacle and generate sensor output values in accordance with the distance to the obstacle, wherein
the front obstacle sensors are disposed at least at three places of a central portion of a front face of the body, and right and left, two sides at the back of the central portion,
front lateral-wall sensors disposed at right and left, two sides of the front side of the body, and rear lateral-wall sensors disposed at right and left, two sides of the back side of the body are included as the lateral wall sensors, and
the cleaner includes a vertical correction and control mechanism that turns the body by a certain angle in the clockwise direction when the obstacle is sensed by the front obstacle sensor at a right side while the body is traveling toward the obstacle, and turns the body by a certain angle in the counterclockwise direction when the obstacle is sensed by the front obstacle sensor at a left side, thereby corrects a direction of the body to be perpendicular to the front obstacle, and
a parallel correction and control mechanism that turns the body by 90 degrees using the gyro sensor after the direction of the body has been made perpendicular to the front obstacle by the vertical correction and control mechanism, and then turns the body by a certain angle in the clockwise direction when a sensor output value of the front lateral-wall sensor at the left side is larger than that of the rear lateral-wall sensor at the left side, or when a sensor output value of the rear lateral-wall sensor at the right side is larger than that of the front lateral-wall sensor at the right side, and turns the body by a certain angle in the counterclockwise direction when a sensor output value of the front lateral-wall sensor at the right side is larger than that of the rear lateral-wall sensor at the right side, or when a sensor output value of the rear lateral-wall sensor at the left side is larger than that of the front lateral-wall sensor at the left side, thereby corrects the direction of the body to be parallel to the obstacle.

2. A self-propelled cleaner including a driving mechanism for realizing steering and driving, a cleaner mechanism, a gyro sensor for detecting an angle of direction to which the body is coursing, front obstacle sensors that sense a front obstacle and measure a distance to the obstacle, and lateral wall sensors that sense a lateral obstacle and generate sensor output values in accordance with the distance to the obstacle, wherein
the front obstacle sensors are disposed at least at three places of a central portion of a front face of the body, and right and left, two sides at the back of the central portion,
front lateral-wall sensors disposed at right and left, two sides of the front side of the body, and rear lateral-wall sensors disposed at right and left, two sides of the back side of the body are included as the lateral wall sensors, and
the cleaner includes a vertical correction and control mechanism that corrects a direction of the body to be perpendicular to the front obstacle using the front obstacle sensors disposed at the three places, and
a parallel correction and control mechanism that turns the body by 90 degrees using the gyro sensor after the direction of the body has been made perpendicular to the front obstacle by the vertical correction and control mechanism, and then corrects the direction of the body to be parallel to the obstacle using the front lateral-wall sensors and the rear lateral-wall sensors.

3. The self-propelled cleaner according to claim 2, wherein
the vertical correction and control mechanism turns the body by a certain angle in the clockwise direction when the obstacle is sensed by the front obstacle sensor at the right side while the body is traveling to the obstacle, and the mechanism turns the body by a certain angle in a counterclockwise direction when the obstacle is sensed by the front obstacle sensor at the left side.

4. The self-propelled cleaner according to claim 2, wherein
when a sensor output value of the front lateral-wall sensor at the left side is larger than that of the rear lateral-wall sensor at the left side, or when a sensor output value of the rear lateral-wall sensor at the right side is larger than that of the front lateral-wall sensor at the right side, the parallel correction and control mechanism turns the body by a certain angle in the clockwise direction, and when a sensor output value of the front lateral-wall sensor at the right side is larger than that of the rear lateral-wall sensor at the right side, or when a sensor output value of the rear lateral-wall sensor at the left side is larger than that of the front lateral-wall sensor at the left side, the mechanism turns the body by a certain angle in the counterclockwise direction.

5. The self-propelled cleaner according to claim 2, wherein
front lateral-wall sensors and rear lateral-wall sensors including photo-reflectors having light emitting sections that emit infrared rays and light receiving sections that receive the infrared rays reflected by a wall are provided as the lateral-wall sensors on left and right, both sides of the front side of the body and left and right, both sides of the back side of the body respectively, and
respective lateral wall sensors generate larger sensor output values with decrease in distance to a lateral wall, detect the lateral wall to keep a certain interval to the wall during traveling.

6. The self-propelled cleaner according to claim 2, wherein
front obstacle sensors including ultrasonic sensors, which have transmitter sections for generating supersonic waves and receiver sections for receiving the supersonic waves that are transmitted by the transmitter sections, reflected by a front wall, and returned, and can calculate a distance to the wall from a period between transmission of the supersonic waves by the transmitter sections and reception of the waves by the receiver sections, are provided as the front obstacle sensors at the central portion of the front face of the body, a right side with respect to an advance direction, and a left side with respect to the advance direction, respectively.

7. The self-propelled cleaner according to claim 6, wherein
the vertical correction and control mechanism determines that whether the front obstacle was sensed by one of the three ultrasonic sensors during straight traveling of the body, and when the obstacle was sensed by one of the ultrasonic sensors,
first, determines whether the front obstacle was sensed by the ultrasonic sensor disposed at the right side with respect to the advance direction, and when it was determined that the obstacle was sensed by the ultrasonic sensor at the right side, since the advance direction of the body is inclined to a left side with respect to perpendicular to the obstacle, practices a process of turning the body by a certain angle in the clockwise direction, so that the direction of the body is close to perpendicular to the obstacle, and
next, determines whether the front obstacle was sensed by the ultrasonic sensor disposed at the left side with respect to the advance direction, and since a fact that the obstacle is also sensed by the ultrasonic sensor at the left side while the obstacle has been detected by the ultrasonic sensor at the right side means that a distance from the ultrasonic sensor at the right side to the obstacle is equal to a distance from the ultrasonic sensor at the left side to the obstacle, determines that the direction of the body is perpendicular to the obstacle.

8. The self-propelled cleaner according to claim 6, wherein
when the obstacle was fist sensed by the ultrasonic sensor at the central portion among the three ultrasonic sensors, the vertical correction and control mechanism determines that the direction of the body is perpendicular to the obstacle.

9. The self-propelled cleaner according to claim 6, wherein
when the vertical correction and control mechanism determines that the front obstacle is not sensed by the ultrasonic sensor at the central portion, next, the mechanism determines that whether the front obstacle was sensed by the ultrasonic sensor disposed at the left side with respect to the advance direction among the three ultrasonic sensors, and when the obstacle was sensed by the ultrasonic sensors at the left side, since the advance direction of the body is inclined to a right side with respect to perpendicular to the obstacle, practices a process of turning the body by a certain angle in the counterclockwise direction, so that the direction of the body is close to perpendicular to the obstacle.

10. The self-propelled cleaner according to claim 2, wherein
CPU as a control section, ROM, and RAM are connected to the body via a bus, and the CPU uses the RAM as a work area to execute various types of control according to a control program and various parameter tables stored in the ROM.

11. The self-propelled cleaner according to claim 2, wherein the drive mechanism has a pair of motor drivers, left and right drive wheel motors, left and right drive wheels, and a gear unit arranged between the drive wheel motors and the drive wheels, and in the drive wheel motors, a rotation direction and a rotation angle are controllably driven in full by the motor drivers when they travel with turns, and according to control instructions from the CPU, the respective motor drivers output driving signals corresponding to the instructions.
